(19) United States
(12) Patent Application Publication
(10) Pub. No.: US 2017/0245113 A1
(43) Pub. Date: Aug. 24, 2017

(54) SELECTING A LOCATION DETERMINATION METHOD FOR A MOBILE DEVICE WITHIN A WIRELESS COMMUNICATION NETWORK

(71) Applicant: T-Mobile USA, Inc., Bellevue, WA (US)

(72) Inventor: William Michael Hooker, Seattle, WA (US)

(21) Appl. No.: 15/052,590

(22) Filed: Feb. 24, 2016

(51) Int. Cl. H04W 4/02; H04W 72/06

(52) U.S. Cl. CPC H04W 4/025; H04W 4/023; H04W 72/06

(57) ABSTRACT

A method of selecting a location determination method for a mobile device within a wireless communication network. For example, the method may be selected based upon how the mobile device accessed the wireless communication network and the capabilities of the mobile device. Thus, possible technologies for determining the location of the mobile device include, but are not limited to, using a Location Retrieval Function (LRF), an Enhanced Serving Mobile Location Center (E-SMLC), a Global Positioning System (GPS), triangulation and accessing a National Emergency Address Database (NEAD). Additionally, multiple methods and/or technologies may be used to determine the mobile device's location and the method or methods may be selected based upon levels of trust with respect to the results.

### BACKGROUND

In recent years, telecommunication devices have advanced from offering simple voice calling services within wireless networks to providing users with many new features. Telecommunication devices now provide messaging services such as email, text messaging, and instant messaging; data services such as Internet browsing; media services such as storing and playing a library of favorite songs; location services; and many others. In addition to the new features provided by the telecommunication devices, users of such telecommunication devices have greatly increased. Such an increase in users is only expected to continue and in fact, it is expected that there could be a growth rate of twenty times more users in the next few years alone. Such an increase in wireless traffic has no place to go and thus, the performance of wireless networks will suffer.

When a user of a telecommunication device (referred to herein as a mobile device) within a wireless communication network utilizes their mobile device in an emergency situation, it is necessary to determine the location of the user and the mobile device so that help can be provided. Additionally, it is often desirable to determine the location of the mobile device in non-emergency situations. Generally, Location Technology is often dependent upon radio access technology and capabilities of the mobile device. For example, if the user accessed the wireless communication network via a communication network such as, for example, a wireless communication network following the long-term evolution (LTE) protocol, then the user's location will generally utilize a control plane solution to obtain the location of the mobile device. Thus, the location solution used is likely related to a combination of the type of the wireless communication network, network capability, device capability, and use case. However, if the user accessed the wireless communication network via, for example, the Internet, then the location of the mobile device will generally be determined utilizing one of user plane solutions. The network may also consider location information derived from the mobile device and sent to the network via a variety messages (registration messages, call messages. The network may use access point (AP) information (e.g., AP-Wi-Fi, Bluetooth, etc.) seen by the mobile device and query a server with the location of visible APs. By utilizing only one method for determining a location of a mobile device, the accuracy of the determined location may not be as accurate as desired. Indeed, it may actually be difficult to determine the location of the user and the mobile device based upon the single method of attempting to determine the location.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 illustrates a wireless communication network, in accordance with various embodiments.

FIG. 2 is a flowchart illustrating a method of selecting a location determination method for a mobile device within the wireless communication network of FIG. 1.

FIG. 3 illustrates a component level view of a mobile device for use in the wireless communication network of FIG. 1.

FIG. 4 illustrates a component level view of a server configured to select a location determination method for a mobile device within the wireless communication network of FIG. 1.

### DETAILED DESCRIPTION

Described herein is a wireless communication network that includes architecture for determining a location of a mobile device, which is using either emergency service or non-emergency within the wireless communication network, from among multiple methods for determining the mobile device's location. For example, the method may be selected based upon how the mobile device accessed the wireless communication network and the capabilities of the mobile device. Possible technologies for determining the location of the mobile device include, but are not limited to, using a Location Retrieval Function (LRF), an Enhanced Serving Mobile Location Center (E-SMLC), a Global Positioning System (GPS), triangulation and accessing a National Emergency Address Database (NEAD) and possible methods using the technologies include, but are not limited to using control plane signaling and associated location servers, using user plane signaling and associated location servers, and using location information embedded in messages from the mobile device to the network.

In an embodiment, a user uses their mobile device within the wireless communication network in order to access emergency services. For example, the user may use the mobile device to place a 911 call. The user may also use their mobile device within the wireless communication network in order to access non-emergency services in other embodiments. The user can be registered with the wireless communication network, i.e., a subscriber, or may not be registered with the wireless communication network, i.e. roaming. If the wireless communication network with which the user is registered is able to identify the user is outbound roaming, the wireless communication network may also use that information to request device location information from the roaming partner (network) if the wireless communication network's location servers are not capable of locating the mobile device In order to determine the mobile device's location, a gateway within the wireless communication network determines the location of the mobile device. The gateway can look at a number of factors and then, based upon available methods for determining the mobile device's location, dynamically determine the best way to determine the location of the mobile device. For example, the gateway may look at the capabilities of the mobile device and/or how the mobile device accessed the wireless communication network. In an embodiment, the gateway can access an Enhanced Equipment Identity Registry in order to identify the mobile device and thereby determine its capabilities.

Once available methods for determining the mobile device's location are determined, one of the methods may be selected for use in determining the mobile device's location. Factors in determining which method to use can include, for example, which methods are most trustworthy, e.g., quality of position (QoP). In embodiments, some methods might not even be attempted if the requested QoP is not very high. This is a way in which the wireless communication network can conserve network resources. Some location methods require greater resources to perform adequately. Additionally, multiple methods may be used in order to determine the location of the mobile device with the results being provided with a level of trust. The location having the highest level of trust can then be selected as the location of the mobile device. Additionally, results from one or more of the methods can be compared to a base tower within a cell of the wireless network that the mobile device was accessing. For example, if one of the methods determines that the location of the mobile device is 20,000 kilometers from the base tower, then it is fairly likely that the method used for determining the location of the mobile device did not provide an accurate result.

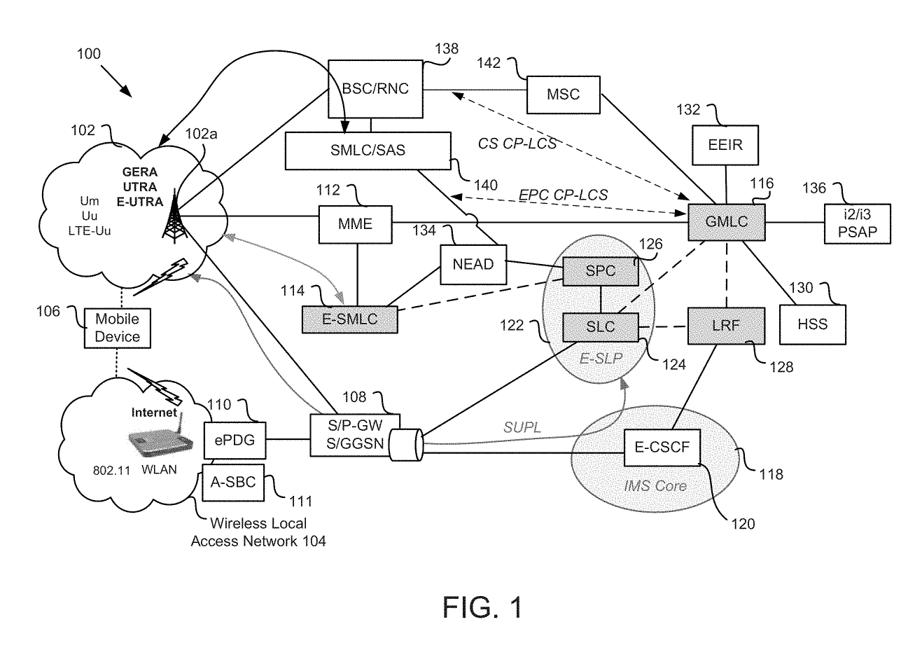

FIG. 1 illustrates a wireless communication network 100 (also referred to herein as “network 100”). The network 100 comprises wireless network 102 that includes a base station 102a and a Wireless Local Access Network (WLAN) 104 for accessing the network 100. The base station 102a may communicate with a mobile device 106 using one or more standards, including but not limited to, Global System for Mobile Communications (GSM), Internet Protocol (IP) Multimedia Subsystem (IPS or IMS), Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), WiMAX protocols (including Institute of Electrical and Electronics Engineers (IEEE) 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like. The WLAN 104 generally accesses the network 100 via the Internet according to, for example, IEEE 802.11 protocols, or via a session border controller for voice-over internet protocol (VoIP) networks.

The mobile device 106 is generally capable of accessing the network 100 wirelessly via either the wireless communication network 102 or the WLAN 104 in order to perform various functions such as, for example, make phone calls, send messages, access the Internet, etc. The mobile device 106 may comprise any appropriate device for communicating over the wireless communication network 100. Such devices include mobile telephones, cellular telephones, mobile computers, Personal Digital Assistants (PDAs), radio frequency devices, handheld computers, laptop computers, tablet computers, palmtops, pagers, integrated devices combining one or more of the preceding devices, and/or the like.

Generally, if the mobile device accessed the network 100 via the wireless network 102, the mobile device 106 generally will communicate with a gateway, more particularly, a gateway General Packet Radio Service (GPRS) support node (GGSN) 108 (also referred to herein as “gateway 108”). If the mobile device 106 communicates via the WLAN 104, the mobile device 106 will communicate via an evolved packet data gateway 110 (ePDG) or a session border controller (A-SBC) 111 and then communicate with the gateway 108.

While only one gateway 108 is illustrated, the gateway 108 generally represents the GGSN, a serving gateway (S-GW), a packet data network gateway (P-GW) and a Serving GPRS support node (SGSN). The gateway 108 is responsible for the internetworking between the GPRS network and external packet switched networks, like the Internet and X.25 networks. The gateway 108 converts the GPRS packets coming from the SGSN into the appropriate packet data protocol (PDP) format (e.g., IP or X.25) and sends them out on the corresponding packet data network. In the other direction, PDP addresses of incoming data packets are converted to the GSM address of the destination user. The readdressed packets are sent to the responsible SGSN. For this purpose, the GGSN stores the current SGSN address of the user and their profile in its location register. The GGSN is responsible for IP address assignment and is the default router for a connected mobile device 106. The gateway 108 also performs authentication and charging functions.

The S-GW routes and forwards user data packets, while also acting as the mobility anchor for the user plane during inter-wireless network 102 handovers and as the anchor for mobility between LTE and other 3GPP technologies (terminating S4 interface and relaying the traffic between 2G/3G systems and the P-GW). For idle state mobile devices 106, the S-GW terminates the downlink data path and triggers paging when downlink data arrives for a mobile device 106. The S-GW manages and stores mobile device contexts, e.g. parameters of the IP bearer service, network internal routing information. It also performs replication of the user traffic in case of lawful interception. The P-GW provides connectivity from a mobile device 106 to external packet data networks by being the point of exit and entry of traffic for the mobile device 106. A mobile device 106 may have simultaneous connectivity with more than one P-GW for accessing multiple packet data networks. The P-GW performs policy enforcement, packet filtering for each user, charging support, lawful interception and packet screening.

A mobility management entity (MME) 112 communicates with an enhanced serving mobile location center (E-SMLC) 114. Generally, the E-SMLC 114 can be utilized to determine the location of the mobile device 106. In an embodiment, the E-SMLC can determine the position of the mobile device 106 utilizing, for example, a global positioning system (GPS) or triangulation. The position or location of the mobile device 106 that is determined by the E-SMLC 114 can be communicated to the MME 112 and on to a Gateway Mobile Location Center (GMLC) 116.

Additionally, the mobile device 106, whether it accesses the network 100 via the wireless network 102 or the WLAN 104, can communicate with an IPS or IMS core 118 that includes a call session control function (E-CSCF) 120. The mobile device 106 can also communicate with enhanced service location protocol (E-SLP) 122 that includes a subscriber loop carrier (SLC) 124 and a signaling point code (SPC) 126, which can likewise communicate with the GMLC 116. In embodiments, the mobile device 106 communicates with the E-SLP 122 via a secure user plane (SUPL). The IMS core 118 can communicate with a Location Retrieval Function (LRF) 128, which also communicates with the E-SLP 122 and the GMLC 116. In embodiments, the GMLC 116 communicates within the network 100 via a call session coupling level classification standard (CS CP-LCS) and/or an evolved packet core coupling level classification standard (EPC CP-LCS). The network 100 also includes a home subscriber server 130.

As will be discussed in more detail herein, the network 100 also includes, or has access to, an Enhanced Equipment Identity Registry 132 and a National Emergency Address Database (NEAD) 134. In embodiments, the NEAD 134 may be replaced with (or the network 100 may also include in addition to the NEAD 134) a general database that is not necessarily related to emergencies. For example, such a general may comprise an access point/beacon location database. Generally, the LRF 128 can retrieve location information from the E-CSCF 120 if needed. The E-CSCF 120 can obtain location information for the mobile device 106 from the gateway 108.

The network 100 also includes a base station controller (BSC)/radio network controller (RNC) 138. The BSC/RNC 138 can include or communicate with serving mobile location center (SMLC)/standalone assisted GPS SMLC (SAS) 140 that can be used to determine the location of the mobile device 106 in non-emergency situations and emergency situations. In embodiments, the mobile device can also communicate directly with the SMLC/SAS 140 via the wireless network 102. The BSC/RNC 138 also communicates with a mobile switching center 142.

In accordance with various embodiments, when the mobile device 106 utilizes emergency services within the network 100, for example, places a 911 emergency call, the location of the mobile device needs to be provided to a public-safety access point (PSAP) 136. In order to provide as accurate a location for the mobile device as possible, the gateway 108 can consider the various options for determining the location of the mobile device 106. In order to determine which methods are available, the gateway 108 can consider the capabilities of the mobile device 106 as well as how the mobile device accessed the network 100. In order to determine the capabilities of the mobile device 106, the gateway can identify the device by accessing the EEIR 132, which is a registry of the identifications of mobile devices. Based upon the identification of the mobile device 106, the capabilities of the mobile device 106 can be determined. Likewise, if the mobile device 106 accessed the network 100 via the wireless network 102, the E-SMLC 114 can be utilized to determine the position of the mobile device 106 via, for example, GPS, and/or triangulation. Additionally, if the wireless device 106 accessed the network 100 via the WLAN 104 and made a call through the gateway 108 and through the wireless network 102, then the E-SMLC 114 can also be used to determine the position of the mobile device 106.

In embodiments, the NEAD 134 can be used to determine the location of the mobile device 106. The NEAD 134 is a national emergency address database that includes the addresses of all base towers and access points within wireless communication networks regardless of the carrier that owns and/or operates the base towers and the access points. The NEAD 134 is generally available to all carriers and/or operators of wireless communication networks. Based upon beacons from the base towers and access points and the mobile device 106, a particular base tower or access point can be determined as to which entity the mobile device 106 is communicating with. The address of the tower or access point can then be retrieved from the NEAD 134 and used as the location for the mobile device 106. As previously noted, in embodiments, the NEAD 134 may be a general database that stores the information and is not related to emergencies.

In accordance with various embodiments, more than one method may be used to determine a location of the mobile device 106. A level of trust may be assigned for each result of the various methods. For example, for a first method, it may be determined that the mobile device is 90% likely to be located within a certain area. However, with a second method, it may be determined that it is with 95% certainty that the mobile device is located within an area. Thus, the location provided by the second method may be used. Additionally, if different methods result in one method providing a smaller sized area as to where the mobile device 106 is located, then that area may be given as the location of the mobile device. Once the location of the mobile device 106 has been determined, the location can be provided to the PSAP 136 so that appropriate services can be provided to the user of the mobile device 106.

While the previous example was described with respect to emergency services, e.g., placing a 911 call, the operations can be used to determine the location of the mobile device 106 in non-emergency situations.

Thus, a user can use their mobile device 106 within the wireless communication network 100 in order to access non-emergency or emergency services. For example, the user may use the mobile device 106 to place a 911 call. The user can be registered with the wireless communication network, i.e., a subscriber, or may not be registered with the wireless communication network, i.e. roaming. In order to determine the mobile device's location, the gateway 108 determines the location of the mobile device 106. The gateway 108 can look at a number of factors and then, based upon available methods for determining the mobile device's location, dynamically determine the best way to determine the location of the mobile device 108. For example, the gateway 108 may look at the capabilities of the mobile device 106 and/or how the mobile device 106 accessed the wireless communication network 100, either via the wireless network 102 or the WLAN 104. In an embodiment, the gateway 108 can access the EEIR 132 in order to identify the mobile device 106 and thereby determine its capabilities.

Once available methods for determining the mobile device's location are determined, one of the methods may be selected for use in determining the mobile device's location. Factors in determining which method to use can include, for example, which methods are most trustworthy. Additionally, multiple methods may be used in order to determine the location of the mobile device 106 with the results being provided with a level of trust. The location having the highest level of trust can then be selected as the location of the mobile device 106. Additionally, results from one or more of the methods can be compared to the base tower 102a within a cell of the wireless network 102 that the mobile device 106 was accessing. For example, if one of the methods determines that the location of the mobile device 106 is 20,000 kilometers from the base tower, then it is fairly likely that the method used for determining the location of the mobile device 106 did not provide an accurate result. Additionally, if different methods result in one method providing a smaller sized area as to where the mobile device 106 is located, then that area may be given as the location of the mobile device. Once the location of the mobile device 106 has been determined, the location can be provided to the PSAP 136 so that appropriate services can be provided to the user of the mobile device 106.

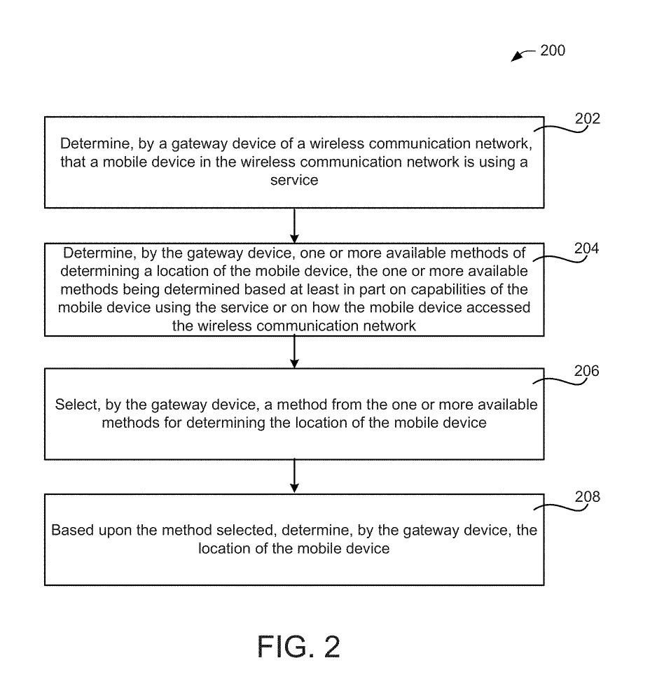

FIG. 2 is a flowchart illustrating a method 200 of selecting a location determination method for a mobile device within a wireless communication network, e.g., mobile device 106 and wireless communication network 100. As illustrated, at block 202, a gateway device of a wireless communication network determines that a mobile device in the wireless communication network is using a service. At block 204, the gateway device determines one or more available methods of determining a location of the mobile device, the one or more available methods being determined based at least in part on capabilities of the mobile device using the service or on how the mobile device accessed the wireless communication network. At block 206, the gateway device selects a method from the one or more available methods for determining the location of the mobile device. At block 208, based upon the method selected, the gateway device determines the location of the mobile device.

### Example Devices

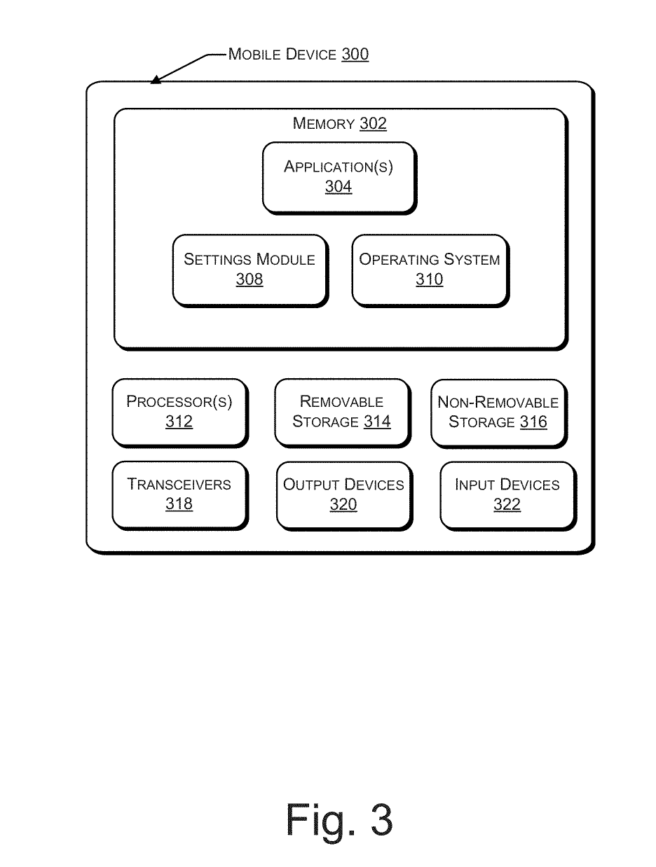

FIG. 3 illustrates a component level view of a mobile device 300, such as mobile device 106, for use in the network 100 and configured to carry out various functions as described herein. As illustrated, the user device 300 comprises a system memory 302 storing application(s) 304, a settings module 308, and an operating system 310. Also, the user device 300 includes processor(s) 312, a removable storage 314, a non-removable storage 316, transceivers 318, output device(s) 320, and input device(s) 322.

In some implementations, the processor(s) 312 is a central processing unit (CPU), a graphics processing unit (GPU), or both CPU and GPU, or any other sort of processing unit. The user device 300 may also include additional data storage devices (removable and/or non-removable) such as, for example, magnetic disks, optical disks, or tape. Such additional storage is illustrated in FIG. 3 by removable storage 314 and non-removable storage 316.

Non-transitory computer-readable media may include volatile and nonvolatile, removable and non-removable tangible, physical media implemented in technology for storage of information, such as computer readable instructions, data structures, program modules, or other data. System memory 302, removable storage 314 and non-removable storage 316 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the user device 300. Any such non-transitory computer-readable media may be part of the user device 300.

In some implementations, the transceivers 318 include any sort of transceivers known in the art. For example, the transceivers 318 may include a radio transceiver that performs the function of transmitting and receiving radio frequency communications via an antenna. Also or instead, the transceivers 318 may include wireless modem(s) to may facilitate wireless connectivity with other computing devices. Further, the transceivers 318 may include wired communication components, such as an Ethernet port, for communicating with other networked devices.

In some implementations, the output devices 320 include any sort of output devices known in the art, such as a display (e.g., a liquid crystal display), speakers, a vibrating mechanism, or a tactile feedback mechanism. Output devices 320 also include ports for one or more peripheral devices, such as headphones, peripheral speakers, or a peripheral display.

In various implementations, input devices 322 include any sort of input devices known in the art. For example, input devices 322 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

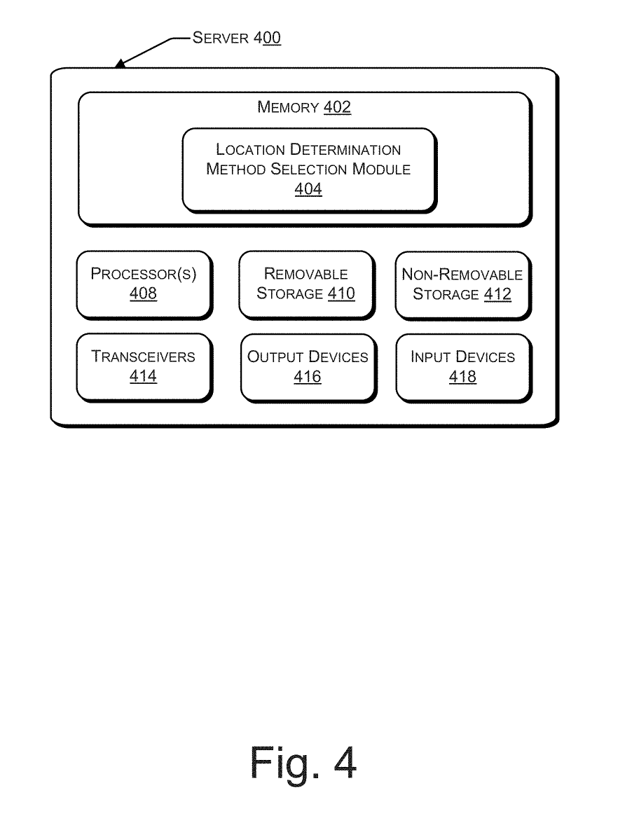

FIG. 4 illustrates a component level view of a server configured to select a method of determining a location of a mobile device, such as mobile device 106, according to the techniques described herein. The server 400 may be located in the gateway 108. Additionally, the server 400 may be a separate entity located separately from the gateway 108 and may also comprise one or more of the LRF 128, the GMLC 116, the SPC 126, the SMLC 114, 140, etc. As illustrated, the server 400 comprises a system memory 402. The system memory 402 includes a Location Determination Selection Module 404. Also, the server 400 includes processor(s) 408, a removable storage 410, a non-removable storage 412, transceivers 414, output device(s) 416, and input device(s) 418.

In various implementations, system memory 402 is volatile (such as RAM), non-volatile (such as ROM, flash memory, etc.) or some combination of the two.

In some implementations, the processor(s) 408 is a central processing unit (CPU), a graphics processing unit (GPU), or both CPU and GPU, or any other sort of processing unit.

The server 400 may also include additional data storage devices (removable and/or non-removable) such as, for example, magnetic disks, optical disks, or tape. Such additional storage is illustrated in FIG. 4 by removable storage 410 and non-removable storage 412.

Non-transitory computer-readable media may include volatile and nonvolatile, removable and non-removable tangible, physical media implemented in technology for storage of information, such as computer readable instructions, data structures, program modules, or other data. System memory 402, removable storage 410 and non-removable storage 412 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the server 400. Any such non-transitory computer-readable media may be part of the server 400.

In some implementations, the transceivers 414 include any sort of transceivers known in the art. For example, the transceivers 414 may include wired communication components, such as an Ethernet port, for communicating with other networked devices. Also or instead, the transceivers 414 may include wireless modem(s) to may facilitate wireless connectivity with other computing devices. Further, the transceivers 414 may include a radio transceiver that performs the function of transmitting and receiving radio frequency communications via an antenna.

In some implementations, the output devices 416 include any sort of output devices known in the art, such as a display (e.g., a liquid crystal display), speakers, a vibrating mechanism, or a tactile feedback mechanism. Output devices 416 also include ports for one or more peripheral devices, such as headphones, peripheral speakers, or a peripheral display.

In various implementations, input devices 418 include any sort of input devices known in the art. For example, input devices 418 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

I claim:

1. A method comprising:
determining, by a gateway of a wireless communication network, that a mobile device in the wireless communication network is using a service;
determining, by the gateway, one or more available methods of determining a location of the mobile device, the one or more available methods being determined based at least in part on capabilities of the mobile device using the service or on how the mobile device accessed the wireless communication network;
selecting, by the gateway, a method from the one or more available methods for determining the location of the mobile device; and
based upon the method selected, determining, by the gateway, the location of the mobile device.

2. The method of claim 1, wherein the gateway comprises at least one of (i) a gateway General Packet Radio Service (GPRS) support node (GGSN), (ii) comprises a Serving GPRS support node (SGSN), (iii) a serving gateway (S-GW) or (iv) a packet data network gateway (P-GW).

3. The method of claim 1, further comprising accessing an Enhanced Equipment Identity Registry to identify the capabilities of the mobile device.

4. The method of claim 1, wherein selecting a method from the one or more methods for determining the location of the mobile device comprises selecting a method from the one or more methods for determining the location of the mobile device based upon one method being trusted more than another method.

5. The method of claim 1, wherein selecting a method from the one or more methods for determining the location of the mobile device comprises selecting multiple methods from the one or more methods and the method further comprises:
determining, by the gateway, corresponding multiple locations of the mobile device using the multiple methods selected; and
for each location of the multiple locations, determining a level of trust as to the likelihood that a particular location is the location of the mobile device,
wherein determining the location of the mobile device comprises selecting one of the multiple locations having the highest level of trust.

6. The method of claim 5, wherein determining a level of trust as to the likelihood that a particular location is the location of the mobile device comprises comparing each location of the multiple locations with a location of a base station of a cell within the wireless communication network accessed by the mobile device.

7. The method of claim 6, wherein the multiple methods comprise two or more of using (i) a Location Retrieval Function, (ii) an Enhanced Serving Mobile Location Center, (iii) a Global Positioning System, (iv) triangulation and (v) accessing a National Emergency Address Database.

8. A gateway of a wireless communication network comprising:
a processor; and
instructions that, when executed by the processor, cause the gateway to perform operations including:
determine that a mobile device in the wireless communication network is using a service;
determine one or more available methods of determining a location of the mobile device, the one or more available methods being determined based at least in part on capabilities of the mobile device using the service or on how the mobile device accessed the wireless communication network;
select a method from the one or more available methods for determining the location of the mobile device; and
based upon the method selected, determine the location of the mobile device.

9. The gateway of claim 8, wherein the gateway comprises at least one of (i) a gateway General Packet Radio Service (GPRS) support node (GGSN), (ii) comprises a Serving GPRS support node (SGSN), (iii) a serving gateway (S-GW) or (iv) a packet data network gateway (P-GW).

10. The gateway of claim 8, wherein the instructions are further executable by the processor to cause the gateway to further perform operations including access an Enhanced Equipment Identity Registry to identify the capabilities of the mobile device.

11. The gateway of claim 8, wherein the method is selected from the one or more methods based upon one method being trusted more than another method.

12. The gateway of claim 8, wherein the instructions are further executable by the processor to cause the gateway to further perform operations including:
select multiple methods from the one or more methods;
determine multiple locations of the mobile device using the multiple methods selected; and
for each location of the multiple locations, determine a level of trust as to the likelihood that a particular location is the location of the mobile device,
wherein the location of the mobile device is determined by selecting one of the multiple locations having the highest level of trust.

13. The gateway of claim 12, wherein the level of trust is determined by comparing each location of the multiple locations with a location of a base station of a cell within the wireless communication network accessed by the mobile device.

14. The gateway of claim 12, wherein the multiple methods comprise two or more of using (i) a Location Retrieval Function, (ii) an Enhanced Serving Mobile Location Center, (iii) a Global Positioning System, (iv) triangulation and (v) accessing a National Emergency Address Database.

15. An apparatus comprising:
a non-transitory storage medium; and
instructions stored in the tangible storage medium, the instructions being executable by the apparatus to:
determine that a mobile device in a wireless communication network is using a service;
determine one or more available methods of determining a location of the mobile device, the one or more available methods being determined based at least in part on capabilities of the mobile device using the service or on how the mobile device accessed the wireless communication network;
select a method from the one or more available methods for determining the location of the mobile device; and
based upon the method selected, determine the location of the mobile device.

16. The apparatus of claim 15, wherein apparatus is included within a gateway that comprises at least one of (i) a gateway General Packet Radio Service (GPRS) support node (GGSN), (ii) comprises a Serving GPRS support node (SGSN), (iii) a serving gateway (S-GW) or (iv) a packet data network gateway (P-GW).

17. The apparatus of claim 15, wherein the instructions are further executable by the apparatus to access an Enhanced Equipment Identity Registry to identify the capabilities of the mobile device.

18. The apparatus of claim 15, wherein the method is selected from the one or more methods based upon one method being trusted more than another method.

19. The apparatus of claim 15, wherein the instructions are further executable by the apparatus to:
select multiple methods from the one or more methods;
determine multiple locations of the mobile device using the multiple methods selected; and
for each location of the multiple locations, determine a level of trust as to the likelihood that a particular location is the location of the mobile device,
wherein the location of the mobile device is determined by selecting one of the multiple locations having the highest level of trust.

20. The apparatus of claim 19, wherein the level of trust is determined by comparing each location of the multiple locations with a location of a base station of a cell within the wireless communication network accessed by the mobile device.

21. The apparatus of claim 19, wherein the multiple methods comprise two or more of using (i) a Location Retrieval Function, (ii) an Enhanced Serving Mobile Location Center, (iii) a Global Positioning System, (iv) triangulation and (v) accessing a National Emergency Address Database.
